(19) United States
(12) Patent Application Publication
(10) Pub. No.: US 2013/0275943 A1
(43) Pub. Date: Oct. 17, 2013

(54) DETERMINING INTERFACE DIFFERENCES BETWEEN DIFFERENT VERSIONS OF AN OPERATING SYSTEM

(71) Applicants: Avinash Namjoshi, Bangalore (IN); Stefan Schneider, Walldorf (DE)

(72) Inventors: Avinash Namjoshi, Bangalore (IN); Stefan Schneider, Walldorf (DE)

(73) Assignee: Oracle International Corporation, Redwood Shores, CA (US)

(21) Appl. No.: 13/443,909

(22) Filed: Apr. 11, 2012

(51) Int. Cl. G06F 9/44

(52) U.S. Cl. 717/122

(57) ABSTRACT

An aspect of the present invention determines interface differences between different versions of an operating system. In one embodiment, the corresponding images of a first (older) version and a second (newer) version is inspected to identify whether access mechanism of a publicly accessible resource associated with a first interface provided by the first version is changed in the second version. Example of change in access mechanism includes a difference in the signature of function type resources, non-existence or change in the name or location of a file type resource and change in the physical file pointed to by a symbolic link type resource in the second version (as compared to that in the first version). A list of publicly accessible resources that are identified as having changed in the second version is then formed.

### BACKGROUND OF THE INVENTION

1. Technical Field

The present disclosure relates to operating systems of digital processing systems, and more specifically to determining interface differences between different versions of an operating system.

2. Related Art

Operating systems generally refer to programs that control access to various hardware facilities present in a computing system. An operating system provides a run-time (or execution) environment in which various applications can be executed as is well known in the relevant arts. Examples of such operating systems include Oracle Solaris operating system, Microsoft Windows XP operating system, Microsoft Windows Server operating system, Redhat Enterprise Linux operating system, Google Android operating system, etc.

An operating system typically provides a corresponding interface (typically as libraries, functions, directory structure, files, etc.), which are used by the applications when executing in a run time environment. Applications are accordingly developed to invoke/use the interface provided by the operating system.

Several versions of a same operating system (OS) often exist. Typically, a newer version of an OS is designed to provide more/different functionality (or for other reasons, such as fixing known bugs, enhanced resource usage efficiency, etc.), compared to an older version. Different versions of an operating system are characterized in that substantial majority of the interfaces provided by the different versions remains the same. For example, Microsoft Windows Server is available in at least two versions referred to as 2008 and 2010. Similarly, Google's Android Operating system is available in at least two versions referred to as v3.x Honeycomb and v4.x Ice Cream Sandwich.

There is a general need to determine the differences of the interfaces provided by different versions of an operating system. For example, such determination may form the basis for formulating approaches for migrating applications from an older version to the newer version of the operating system.

### BRIEF DESCRIPTION OF THE DRAWINGS

Example embodiments of the present invention will be described with reference to the accompanying drawings briefly described below.

FIG. 1A is a block diagram illustrating an example environment (computing system) in which several aspects of the present invention can be implemented.

FIG. 1B is a block diagram illustrating the run-time environment of a server system in one embodiment.

FIG. 2 is a flowchart illustrating the manner in which interface differences between different versions of an operating system are determined according to an aspect of the present invention.

FIG. 3A depicts a portion of a difference list identifying the file type resources whose access mechanism have changed in a newer version of an operating system in one embodiment.

FIG. 3B depicts a portion of a difference list identifying the function type resources whose access mechanism have changed in a newer version of an operating system in one embodiment.

FIG. 3C depicts a portion of a difference list identifying the symbolic link type resources whose access mechanism have changed in a newer version of an operating system in one embodiment.

FIG. 4 depicts a portion of a report generated based on difference list in one embodiment.

FIG. 5 is a block diagram illustrating the details of a digital processing system in which several aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention determines interface differences between different versions of an operating system. In one embodiment, the corresponding images of a first (older) version and a second (newer) version is inspected to identify whether access mechanism of a publicly accessible resource associated with a first interface provided by the first version is changed in the second version. A list of publicly accessible resources that are identified as having changed in the second version is then formed.

In one embodiment, the change in access mechanism includes a difference in the signature of function type resources in the second version, non-existence or change in the name or location of a file type resource in the second version and change in the physical file pointed to by a symbolic link type resource in the second version (as compared to that in said first version).

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

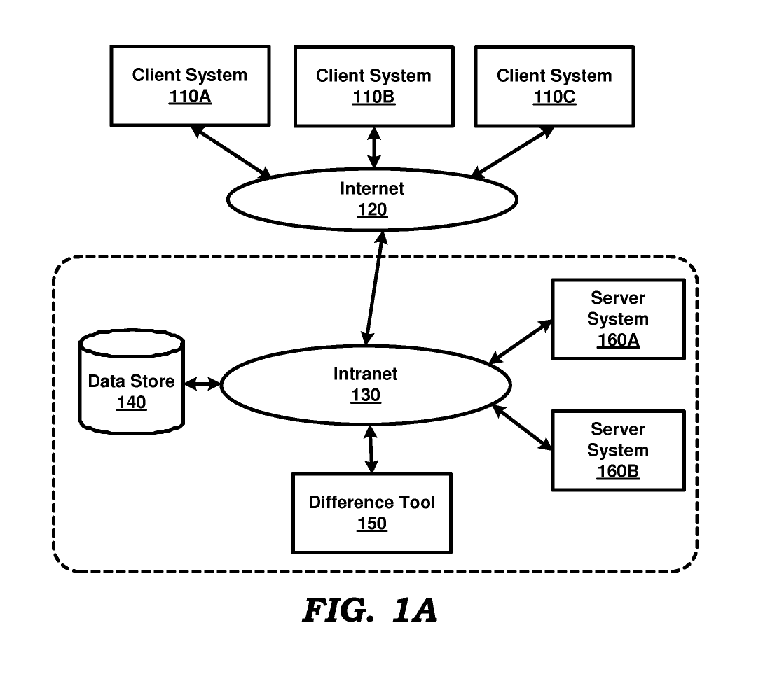

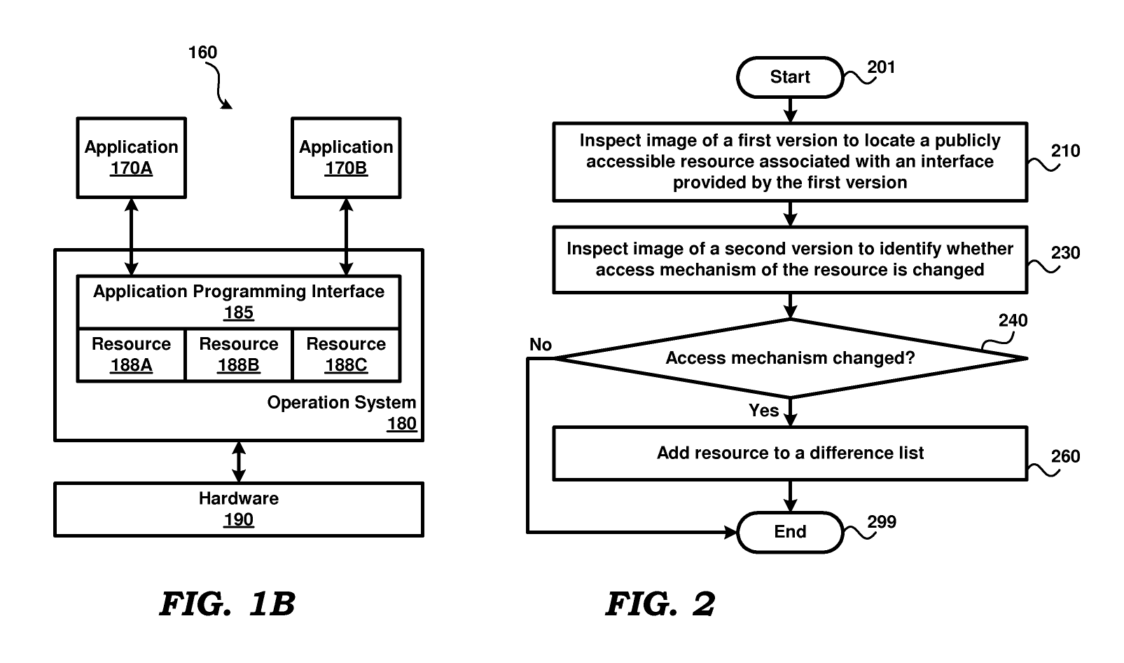

FIG. 1A is a block diagram illustrating an example environment (computing system) in which several aspects of the present invention can be implemented. The block diagram is shown containing client systems 110A-110C, Internet 120, intranet 130, data store 140, difference tool 150, and server systems 160A-160B.

Merely for illustration, only representative number/type of systems is shown in FIG. 1A. Many environments often contain many more systems, both in number and type, depending on the purpose for which the environment is designed. Each system/device of FIG. 1A is described below in further detail.

Intranet 130 represents a network providing connectivity between data store 140, difference tool 150 and server systems 160A-160B, all provided within an enterprise (as indicated by the dotted boundary). Internet 120 extends the connectivity of these (and other systems of the enterprise) with external systems such as client systems 110A-110C. Each of intranet 130 and Internet 120 may be implemented using protocols such as Transmission Control Protocol (TCP) and/or Internet Protocol (IP), well known in the relevant arts.

In general, in TCP/IP environments, an IP packet is used as a basic unit of transport, with the source address being set to the IP address assigned to the source system from which the packet originates and the destination address set to the IP address of the target system to which the packet is to be eventually delivered. An IP packet is said to be directed to a target system when the destination IP address of the packet is set to the IP address of the target system, such that the packet is eventually delivered to the target system by Internet 120 and intranet 130. When the packet contains content such as port numbers, which specifies the target application, the packet may be said to be directed to such application as well.

Each of client systems 110A-110C represents a system such as a personal computer, workstation, mobile station, etc., used by users to generate (client) requests directed to enterprise applications executing in server systems 160A-160B. The requests may be generated using appropriate user interfaces. In general, a client system requests an application for performing desired tasks and receives corresponding responses containing the results of performance of the requested tasks. Each request is sent in the form of an IP packet directed to the desired server system, with the IP packet including data identifying the desired tasks in the payload portion.

Data store 140 represents a non-volatile (persistent) storage facilitating storage and retrieval of data by applications executing in server systems 160A-160B. Data store 140 may be implemented as a corresponding database server using relational database technologies and accordingly provide storage and retrieval of data using structured queries such as SQL (Structured Query Language). Alternatively, data store 140 may be implemented as a corresponding file server providing storage and retrieval of data in the form of files organized as one or more directories, as is well known in the relevant arts.

Each of server systems 160A-160B represents a server, such as a web/application server, executing enterprise applications capable of performing tasks requested by users using one of client systems 110A-110C. A server system may use data stored internally, external data maintained in data store 180 or that received from external sources (e.g., from the user) in performing such tasks. The server system then sends the result of performance of the tasks to the requesting client system (one of 110A-110C).

It may be appreciated that each of server systems 160A-160B may also execute a corresponding operating system that provides a run-time (or execution) environment for execution of the various enterprise applications. Such a run-time environment of a server system is described below with examples.

### 3. Run-time Environment

FIG. 1B is a block diagram illustrating the run-time environment of a server system (e.g., 160B) in one embodiment. Though the features of the present invention are described with respect to server system 160B, it should be appreciated that the features may be implemented in any digital processing system.

Server system 160B is shown containing applications 170A-170B, operating system (OS) 180 and hardware 190. OS 180 is in turn shown containing application programming interface 185 and resources 188A-188C. The details of the server system are shown merely by way of illustration, and the server system may contain other blocks as well in other embodiments. Each of the blocks is described in detail below.

Hardware 190 represents the hardware components (e.g., central processing unit, memory, bus controllers, hardware facilities such as printer interface, serial interfaces, network interfaces, etc.) of server system 160B. The hardware components can be shared among various enterprise (in general, user) applications, which are possibly distributed across multiple computing systems as well.

Each of applications 170A-170B represents a user/enterprise application that is executable or presently executing in server system 160B. As may be readily appreciated, a user application is generally represented/stored in the form of executable modules, which when executed, creates a corresponding application process in volatile memory (such as RAM). The application process represents an active entity capable of performing various tasks (for which the corresponding user application is designed) in response to client requests. It should be appreciated that many application processes (related to same or different user applications) may be executed simultaneously and/or in multi-tasking fashion, based on hardware 190.

OS 180 controls access of applications (processes) to the various hardware facilities in hardware 190. The facilities are typically managed and provided in the form of one or more number and/or type of resources (e.g. files, directories, sockets, functions, etc.). Some of the resources may be internal to OS 180, while other resources may be publicly accessible.

Resources 188A-188C represents some of such publicly accessible resources. A resource is publicly accessible if the resource can be accessed from external to the operating system. Thus, applications 170A and 170B would be able to access the publicly accessible resources (e.g., 188A). Whether a resource is publicly accessible or not, may be determined based on the type of resource and/or any associated declarations/definitions, etc. For example, files type resources in specific locations (i.e., directories) may be deemed to be publicly accessible, while function type resources are deemed to be publicly accessible only if a corresponding declaration is present.

API 185 represents an interface provided by OS 180 to enable applications 170A-170B to access publicly accessible resources such as 188A-188C (and correspondingly access the facilities provided by hardware 190). API 185 is provided in the form of various routines (assumed to be same as procedures) that can be invoked by applications 170A-170B. Thus, an application includes instructions to invoke a routine (with appropriate parameters), while the invoked routine contains instructions that operate to access the resources on behalf of the application. It may be appreciated that for function type resources, the routines are the functions themselves, but for other types of resources routines are the mechanisms for accessing the resources. API 185 may be provided according to the same programming language/environment (e.g., Java™, .NET™) in which applications 170A-170B are developed.

As noted above, an operating system may have several versions, and OS 180 represents one such (older) version. Thus, while applications 170A-170B may (currently) be executing in conjunction with OS 180, it may be desirable that the applications may be migrated to another (newer) version of the operating system. Such migration may be necessitated due to stoppage of support for the older version, for taking advantage of features (e.g., better security, better resource management) provided by the newer version, etc.

It should be appreciated that migration of an application (e.g. 170A) from an older version to a newer version generally entails modifying the instructions of the application to operate with (invoke) the interface provided by the newer version of the operating system. The developers of the application may accordingly wish to identify the specific instructions (routine invocations) that are to be modified in the application. Such identification may be facilitated by knowing the differences between the interfaces provided by different versions of the operating system.

Difference tool 150, provided according to several aspects of the present invention, determines interface differences between different versions of an operating system, as described below with examples. For illustration, it is assumed that both the versions of the operating system and difference tool 150 are executing in server system 160B. However, in alternative embodiments, the different versions may be available on different systems, with difference tool 150 implemented either internal to one of the systems or external to all the systems.

### 4. Determining Interface Differences

FIG. 2 is a flowchart illustrating the manner in which interface differences between different versions of an operating system are determined according to an aspect of the present invention. The flowchart is described with respect to the blocks of FIGS. 1A and 1B merely for illustration. However, many of the features can be implemented in other environments also without departing from the scope and spirit of several aspects of the present invention, as will be apparent to one skilled in the relevant arts by reading the disclosure provided herein. The flow chart begins in step 201, in which control immediately passes to step 210.

In step 210, difference tool 150 inspects image of a first version of operating system 180 to locate a publicly accessible resource associated with an interface provided by the first version. An image of an operating system represents the organization of data corresponding to various resources, when the operating system is installed. The image can be in the form of a pre-installation package (e.g., in ISO image format, well known in the relevant arts) or can be a post-installation organization of data on a digital processing system. Thus, inspection of an image entails examining the data in the corresponding form.

In step 230, difference tool 150 inspects image of a second version of operating system 180 to identify whether the access mechanism of the (publicly accessible) resource is changed. It should be appreciate a change of the access mechanism may cause applications 170A and 170B, to fail when interfacing with the second/newer version of the operating system.

Thus, a change of access mechanism includes aspects such as whether the resource is no longer available in the second version, the resource has been moved to another location (e.g., file moving to a different directory, or function type resource being moved to another library, etc.), or the interface used to access the resource (e.g., name of the resource/interface, the number/type of parameters) has been modified, etc.

In step 240, control passes to 260 if the access mechanism of the resource is determined to have changed, and to step 299 otherwise. In step 260, difference tool 150 adds the resource and corresponding determined change, to a difference list. The flow chart thereafter ends in step 299.

It should be appreciated that the difference list of step 260 is populated with several resources by executing the flowchart of FIG. 2 for each of the resources identified in step 210. The difference list thus represents the interface differences that can be suitably used by various developers of various applications. For example, the difference list may facilitate developers of an application to identify the specific instructions (routine invocations) that are to be modified in the application.

An example difference list determined by difference tool 150 by performing the steps of FIG. 2 (in server system 160B) is described in detail below.

### 5. Difference List

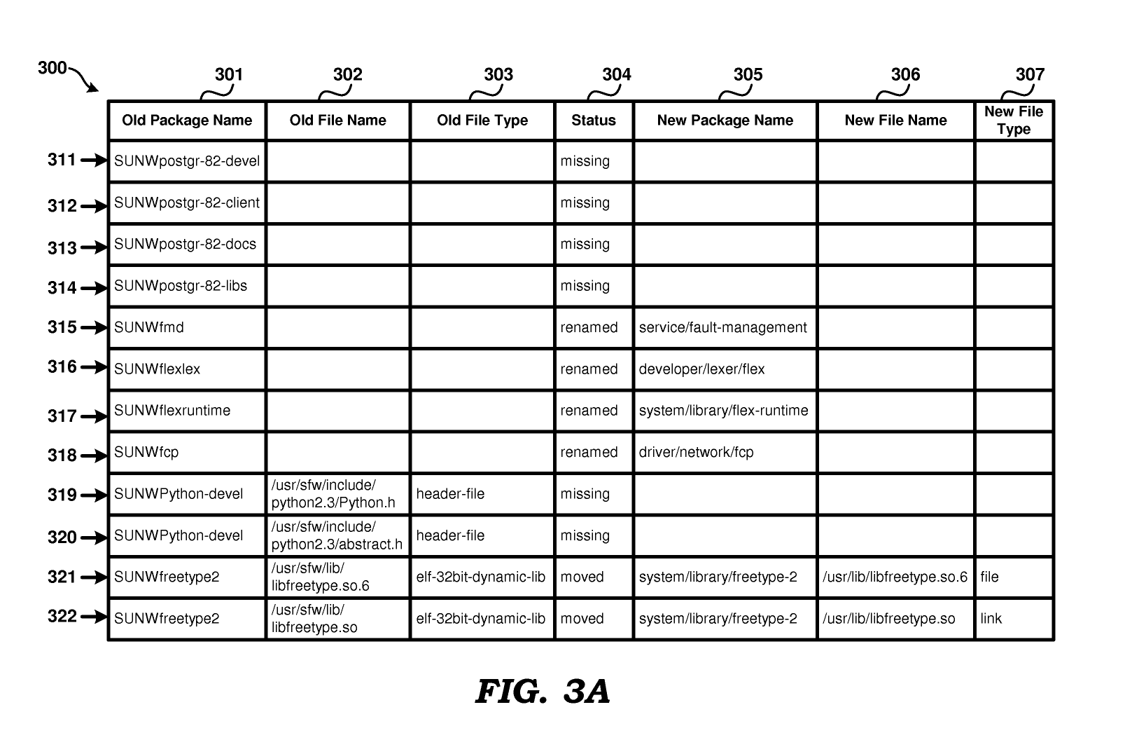

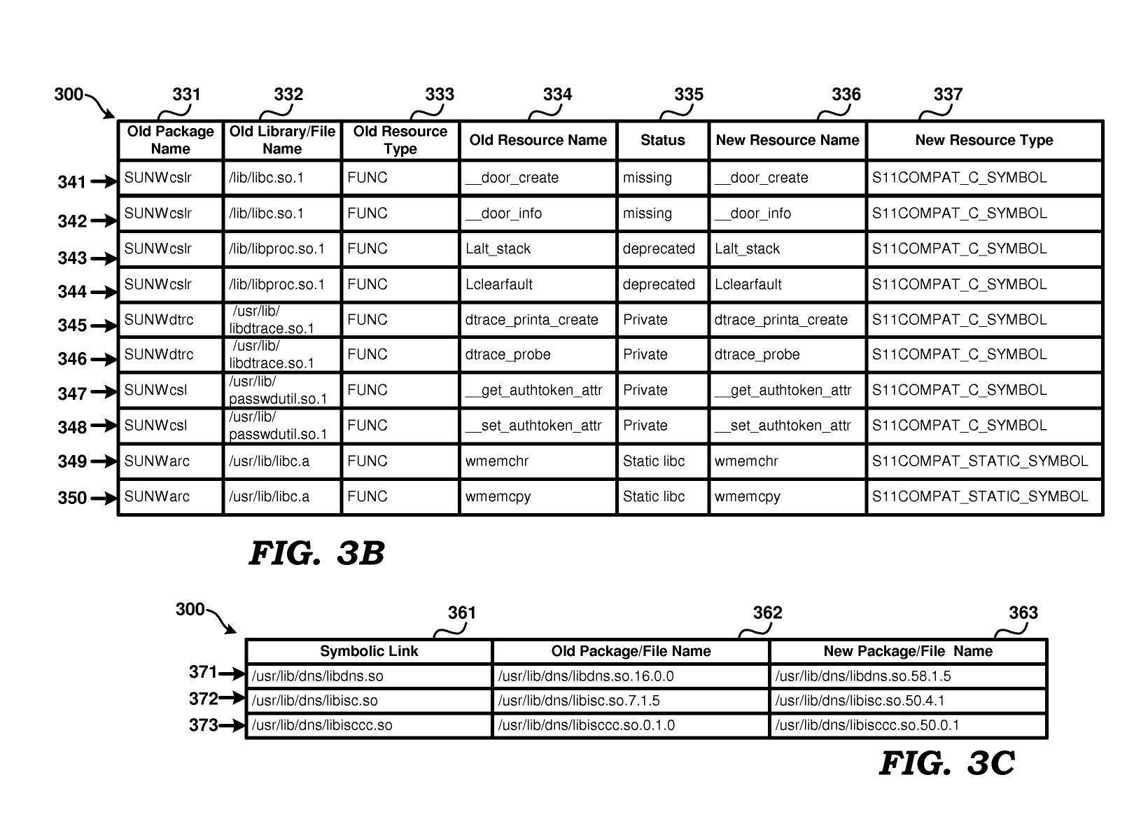

FIGS. 3A-3C depicts portions of a difference list (identifying the interface difference between different versions of an operating system) in one embodiment. The description is provided assuming the depicted interface differences are present between Oracle Solaris TOGA operating system (the older version) and Oracle Solaris 11 operating system (the newer version).

For convenience, difference list 300 is shown in the form of multiple tables. However in alternative embodiments, the data identifying the interface differences may be represented in other formats such as eXtensible Markup Language (XML) and/or other data structures (such as lists, trees, etc.) as will be apparent to one skilled in the relevant art by reading the disclosure herein.

Broadly, FIGS. 3A-3C depict the changed file type, function type and symbolic link type resources respectively. The differences may be identified by difference tool 150 based on comparing the respective images of the older and newer versions. For example, the changed file type resources may be identified by comparing the files/directories in the images. The changed symbolic type resources may be identified by searching for link files (having “.lnk” extension) and then comparing the properties (e.g., the target property indicating the file to which the link points to) of the link files. The changed function type resources may be identified by searching for library files (having “.lib” extensions), inspecting the library files to determine the publicly accessible symbols/functions specified in the library files, and then comparing the determined symbols/functions. Each of the Figures is described in detail below.

FIG. 3A depicts a portion of a difference list (300) identifying the file type resources whose access mechanism have changed in a newer version of an operating system in one embodiment. Each of rows 311-322 specifies the details of a corresponding changed resource. In particular, rows 311-318 specify the details of packages and rows 319-322 specify the details of files changed in the newer version.

It may be appreciated that the inclusion of specific rows in the difference list of FIG. 3A may correspond to modifications made to the operating system. For example, rows 311-314 and rows 319-320 respectively indicate that the “postgre” database and the “python 2.3” interpreter are no longer contained/shipped in the newer version of the operating system (i.e., Oracle Solaris 11). Similarly, rows 315-318 indicate that some of the packages that were named with the prefix “SUN” have been renamed to more descriptive package names.

Columns 301-303 respectively specify the package name, file name and file type of the resource in the older version of the operating system, while columns 305-307 respectively specify the package name, file name and file type of the same resource in the newer version of the operating system. Column 304 indicates the change in access mechanism such as “missing” indicating that the resource is not present (does not exist) in the newer version, “renamed” or “moved” indicating that the resource is accessed by a new name and/or at a new location as specified in columns 305-307.

FIG. 3B depicts a portion of a difference list (300) identifying the function type resources whose access mechanism have changed in a newer version of an operating system in one embodiment. Each of rows 341-350 specifies the details of a corresponding changed resource/function.

Columns 331-334 respectively specify the package name, library/file name, resource type (indicating “FUNC”/function) and function name of the resource in the older version of the operating system, while columns 336-337 respectively specify the resource name and resource type (indicating “S11COMPAT_C_SYMBOL”) of the same resource in the newer version of the operating system. Column 335 indicates the change in access mechanism such as “missing” indicating that the corresponding function is not present in the newer version, “deprecated” indicating that the use of the function is strongly discouraged due to the high probability that the function will be removed in future versions.

The value “private” in column 335 indicates that the usage of these function is reserved for internal use of the operating system and any usage in external applications is discouraged due the high probability that the name, the number/type of parameters, the return type (together referred to as the “signature”) of the function will be modified in future versions. The value “Static libc” in column 335 indicates that the corresponding function should not be linked “statically”, since the implementation of these functions may change in future versions of the operating system. An application statically linking with these libraries not accordingly not work correctly or may crash when executed in the future versions.

FIG. 3C depicts a portion of a difference list (300) identifying the symbolic link type resources whose access mechanism have changed in a newer version of an operating system in one embodiment. Each of rows 371-373 specifies the details of a corresponding changed resource/symbolic link. Column 361 specifies the name of each symbolic link, while columns 362 and 363 specify the names of the corresponding physical packages/files to which the link points to respectively in the older and newer versions of the operating system.

Thus, difference tool 150 maintains the differences between different versions of an operating system in the form of difference list 300, as shown in FIGS. 3A-3C. Difference list 300 may thereafter be used for formulating an approach to migrating application to the newer version as described below with examples.

### 6. Generating Reports

In one embodiment, a developer of an application provides a list of resources accessed by the application, with difference tool 150 thereafter generating a report indicating the possible issues (in the form of errors or warnings) with the list of resources. The developer of the application can then identify the specific portions of the application that needs to be modified to operate with the interface of the newer version. An example output that may be generated by difference tool 150 is described below with examples.

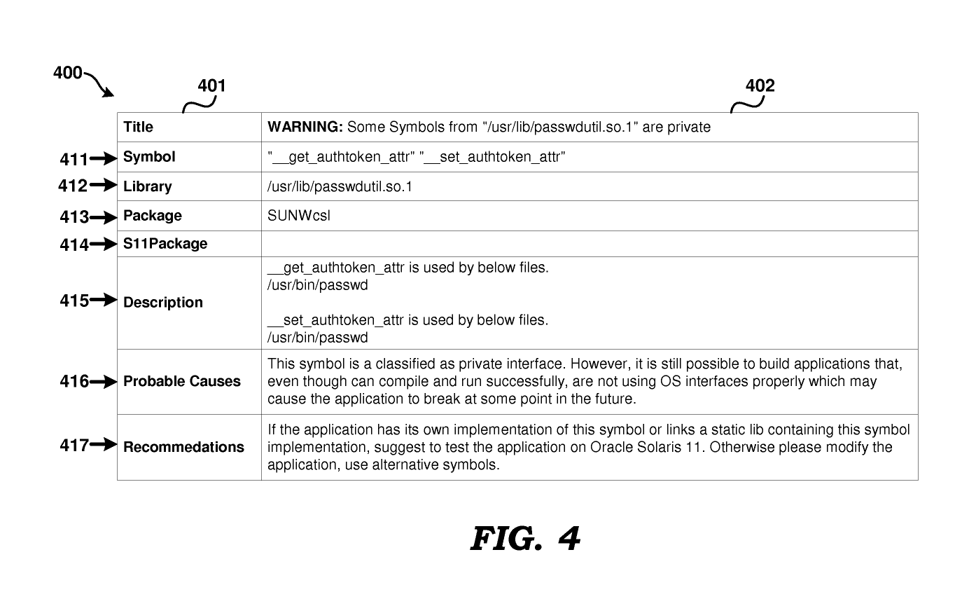

FIG. 4 depicts a portion of a report generated based on difference list in one embodiment. Data portion 400 represents a warning included in a report generated in response to a list of resources received from a developer of an application. It may be appreciated that data portion 400 may be generated corresponding to rows 347 and 348 in response to the functions “_get_authtoken_attr” and “_set_authtoken_attr” being indicated in the list of resources.

Data portion 400 is shown in the form of a table containing a field name (column 401) and an associated value (column 402). Each of rows 411-417 specifies the details of a corresponding field and the associated value. In particular, rows 411-417 respectively specify the title, the name of the symbols/functions (as indicated in column 334), the name of the library (as indicated in column 332), the name of the package (as indicated in column 331), the S11 Package, the description of the issue, the probable causes of the issue and recommendations for fixing the issue. The description, probable cause and recommendations may be generated based on the corresponding value (e.g., “missing”, “private”, “moved”, “renamed”, etc.) in status column 335 of rows 347 and 348.

The developer of the application may accordingly decide to change the portions of the application (indicated in row 415) such that the functions “_get_authtoken_attr” and “_set_authtoken_attr” are not invoked by the application, thereby ensuring that the application can operate with the newer version of the operating system. Similar required action may be taken with respect to other differences identified by difference tool 150 for migration of the application to the newer version of the operating system, as will be apparent to a skilled practitioner by reading the disclosure provided herein.

It should be further appreciated that the features described above can be implemented in various embodiments as a desired combination of one or more of hardware, executable modules, and firmware. The description is continued with respect to an embodiment in which various features are operative when corresponding executable modules are executed.

### 7. Digital Processing System

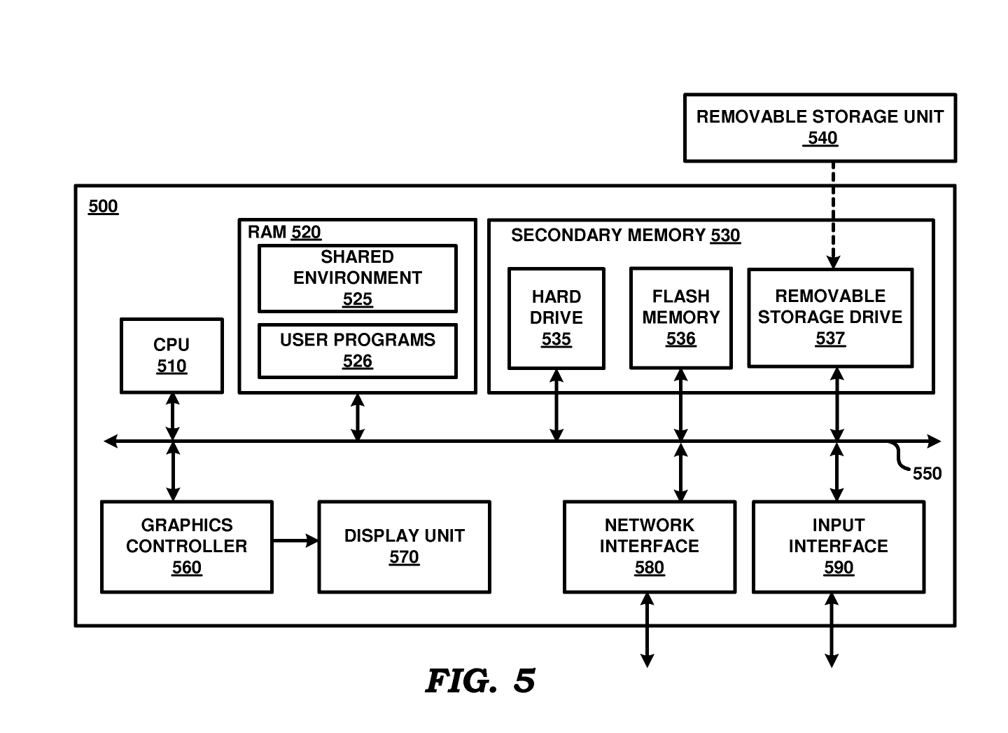

FIG. 5 is a block diagram illustrating the details of digital processing system 500 in which several aspects of the present invention are operative by execution of appropriate executable modules. Digital processing system 500 may correspond to any system (such as server system 160B) executing difference tool 150.

Digital processing system 500 may contain one or more processors (such as a central processing unit (CPU) 510), random access memory (RAM) 520, secondary memory 530, graphics controller 560, display unit 570, network interface 580, and input/output interface 590. All the components except display unit 570 may communicate with each other over communication path 550, which may contain several buses as is well known in the relevant arts.

CPU 510 may execute instructions stored in RAM 520 to provide several features of the present invention. CPU 510 may contain multiple processing units, with each processing unit potentially being designed for a specific task. Alternatively, CPU 510 may contain only a single general-purpose processing unit. Execution of such instructions may provide each of applications 170A-170B and operating system 180.

RAM 520 may receive instructions from secondary memory 530 using communication path 550. RAM 520 is shown currently containing software instructions constituting shared environment 525 and/or user programs 526. Shared environment 525 contains utilities shared by user programs, and such shared utilities include operating system 180, virtual machines, etc., which provide a (common) run-time environment for execution of user programs/applications 526. User programs 526 include difference tool 150 and applications 170A-170B.

Graphics controller 560 generates display signals (e.g., in RGB format) to display unit 570 based on data/instructions received from CPU 510. Display unit 570 contains a display screen to display the images defined by the display signals. Input/output interface 590 includes input as well as output devices to enable a user to interact with system 500, for example, to start execution of modules representing run-time analysis program 150. Network interface 580 provides the physical, electrical and protocol implementations that enable system 500 to communicate with other systems using protocols such as TCP/IP.

Secondary memory 530 (representing a non-transitory storage/medium) may contain hard drive 535, flash memory 536, and removable storage drive 537. Secondary memory 530 may store data and software instructions (for example, for performing the steps of FIG. 2), which enable digital processing system 500 to provide several features in accordance with the present invention, as described above.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable storage medium having stored therein computer software and/or data. However, the computer (or machine, in general) readable storage medium can be in other forms (e.g., non-removable, random access, etc.).

In this document, the term “computer program product” is used to generally refer to secondary memory 530. These computer program products are means for providing software to digital processing system 500. CPU 510 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 8. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of determining interface differences between a first version and a second version of an operating system, said method comprising:
inspecting a first image of said first version and a second image of said second version to identify whether access mechanism of a publicly accessible resource associated with a first interface provided by said first version is changed in said second version; and
forming a list of resources identified as having changed in said second version, wherein said publicly accessible resource is included in said list if said inspecting identifies that the access mechanism of said publicly accessible resource is changed in said first interface provided by said second version.

2. The method of claim 1, wherein said publicly accessible resource is a function type resource,
wherein a change in the access mechanism of said function type resource comprises one of non-existence of said function type resource in said second version and a difference in the signature of said function type resource in said second version as compared to that in said first version.

3. The method of claim 2, wherein the signature comprises a name of said function type resource, a number of parameters accepted by said function type resource, the types of parameters and the return type.

4. The method of claim 2, wherein said change in the access mechanism of said function type resource further comprises marking of said function type resource as deprecated to indicate that the usage of said function type resource is strongly discouraged.

5. The method of claim 2, wherein said change in the access mechanism of said function type resource further comprises marking of said function type resource as private to indicate that the usage of said function type resources is reserved for internal use in said second version and any usage in external applications is discouraged due the high probability that the signature of said function type resource can be changed in future versions of said operating system.

6. The method of claim 2, wherein said change in the access mechanism of said function type resource further comprises marking of said function type resource as not to be linked statically with applications, since the implementation of said function type resource may change in future versions of said operating system.

7. The method of claim 1, wherein said publicly accessible resource is a file type resource, wherein a change in the access mechanism of said file type resource comprises one of non-existence of said file type resource in said second version, change in the name or location of said file type resource in said second version and change in the package containing said file type resource.

8. The method of claim 1, wherein said publicly accessible resource is a symbolic link type resource, wherein a change in the access mechanism of said symbolic link type resource comprises a change in the physical file pointed to by said symbolic link type resource in said second version as compared to that in said first version.

9. The method of claim 1, further comprising:
receiving a set of resources used by an application in said first version of said operating system;
generating a report indicating the specific ones of said set of resources that are contained in said list of resources.

10. A machine readable medium storing one or more sequences of instructions for causing a system to determine interface differences between a first version and a second version of an operating system, wherein execution of said one or more sequences of instructions by said one or more processors contained in said system causes said system to perform the actions of:
inspecting a first image of said first version and a second image of said second version to identify whether access mechanism of a publicly accessible resource associated with a first interface provided by said first version is changed in said second version; and
forming a list of resources identified as having changed in said second version, wherein said publicly accessible resource is included in said list if said inspecting identifies that the access mechanism of said publicly accessible resource is changed in said first interface provided by said second version.

11. The machine readable medium of claim 10, wherein said publicly accessible resource is a function type resource,
wherein a change in the access mechanism of said function type resource comprises one of non-existence of said function type resource in said second version and a difference in the signature of said function type resource in said second version as compared to that in said first version.

12. The machine readable medium of claim 11, wherein the signature comprises a name of said function type resource, a number of parameters accepted by said function type resource, the types of parameters and the return type.

13. The machine readable medium of claim 11, wherein said change in the access mechanism of said function type resource further comprises marking of said function type resource as deprecated to indicate that the usage of said function type resource is strongly discouraged.

14. The machine readable medium of claim 11, wherein said change in the access mechanism of said function type resource further comprises marking of said function type resource as private to indicate that the usage of said function type resources is reserved for internal use in said second version and any usage in external applications is discouraged due the high probability that the signature of said function type resource can be changed in future versions of said operating system.

15. The machine readable medium of claim 11, wherein said change in the access mechanism of said function type resource further comprises marking of said function type resource as not to be linked statically with applications, since the implementation of said function type resource may change in future versions of said operating system.

16. The machine readable medium of claim 10, wherein said publicly accessible resource is a file type resource, wherein a change in the access mechanism of said file type resource comprises one of non-existence of said file type resource in said second version, change in the name or location of said file type resource in said second version and change in the package containing said file type resource.

17. The machine readable medium of claim 10, wherein said publicly accessible resource is a symbolic link type resource, wherein a change in the access mechanism of said symbolic link type resource comprises a change in the physical file pointed to by said symbolic link type resource in said second version as compared to that in said first version.

18. The machine readable medium of claim 10, further comprising one or more instructions for:
receiving a set of resources used by an application in said first version of said operating system;
generating a report indicating the specific ones of said set of resources that are contained in said list of resources.

19. A digital processing system comprising:
a memory to store instructions;
a processor to retrieve said instructions stored in said memory and to execute said instructions, wherein execution of the retrieved instructions causes said digital processing system to perform the actions of:
inspecting a first image of said first version and a second image of said second version to identify whether access mechanism of a publicly accessible resource associated with a first interface provided by said first version is changed in said second version; and
forming a list of resources identified as having changed in said second version, wherein said publicly accessible resource is included in said list if said inspecting identifies that the access mechanism of said publicly accessible resource is changed in said first interface provided by said second version.

20. The digital processing system of claim 19, further performing the actions of:
receiving a set of resources used by an application in said first version of said operating system;
generating a report indicating the specific ones of said set of resources that are contained in said list of resources.
